(19) United States
(12) Patent Application Publication
(10) Pub. No.: US 2025/0387889 A1
(43) Pub. Date: Dec. 25, 2025

(54) IMPACT TOOL

(71) Applicant: TIEN-I INDUSTRIAL CO., LTD., Taichung City (TW)

(72) Inventor: Larry LEE, Taichung City (TW)

(21) Appl. No.: 19/227,779

(22) Filed: Jun. 4, 2025

(30) Foreign Application Priority Data
Jun. 19, 2024 (TW) 113122672

(51) Int. Cl. B25B 27/02

(52) U.S. Cl. CPC B25B 27/02

(57) ABSTRACT

An impact tool is provided, wherein the impact tool includes: a connection rod including a first end portion and a second end portion opposite to each other, the first end portion including a threaded portion, the threaded portion being configured to be screwed to an object, the second end portion including a receiving hole; and an impact rod including a body portion, a working portion and an impacting head, the working portion and the impacting head being disposed at opposite ends of the body portion respectively, the working portion being rotatably received in the receiving hole so that the impact rod is swingable relative to the connection rod.

### BACKGROUND OF THE INVENTION

### FIELD OF THE INVENTION

The present invention relates to a repairing tool, particularly to an impact tool.

### DESCRIPTION OF THE PRIOR ART

In mechanical devices, it is common that components are joined by insertion or embedding means, such as ball joints in automobiles. To assemble or disassemble such components, it is typically done by striking, which only requires a hammer, offering the advantages of simple operation, low cost, and speed. Moreover, the impact force helps loosen parts that are stuck or rusted, making it widely used by maintenance personnel.

However, directly striking with a hammer presents various drawbacks, such as difficulty in precisely controlling the striking point, inconsistency in striking force, which easily leads to damage or deformation of the impacted object, and difficulty for inexperienced users in accurately judging the striking angle, among others.

The present invention is, therefore, arisen to obviate or at least mitigate the above-mentioned disadvantages.

### SUMMARY OF THE INVENTION

The main object of the present invention is to provide an impact tool that, after being integrally assembled with an object via a connection rod, transmits impact force to the connection rod through an impact rod. This method uniformly transmits the impact force to the object, thereby maintaining structural integrity. Additionally, the impact rod is swingable relative to the connection rod, enabling a wider range of striking angles for user convenience.

To achieve the above and other objects, an impact tool is provided, wherein the impact tool includes: a connection rod including a first end portion and a second end portion opposite to each other, the first end portion including a threaded portion, the threaded portion being configured to be screwed to an object, the second end portion including a receiving hole; and an impact rod including a body portion, a working portion and an impacting head, the working portion and the impacting head being disposed at opposite ends of the body portion respectively, the working portion being rotatably received in the receiving hole so that the impact rod is swingable relative to the connection rod.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of FIG. 1;

FIG. 3 is another exploded view of FIG. 1;

FIG. 4 is a cross-sectional view of FIG. 1; and

FIG. 5 is a schematic view showing the use state of the exemplary embodiment of the present invention.

### DETAILED DESCRIPTION OF THE PREFERRED EMBODIMENTS

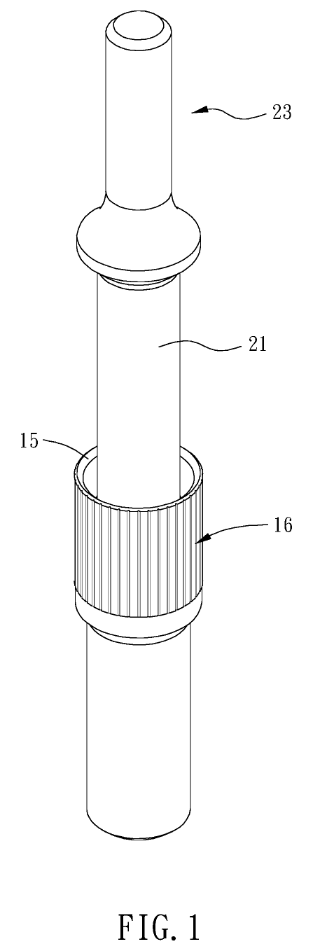

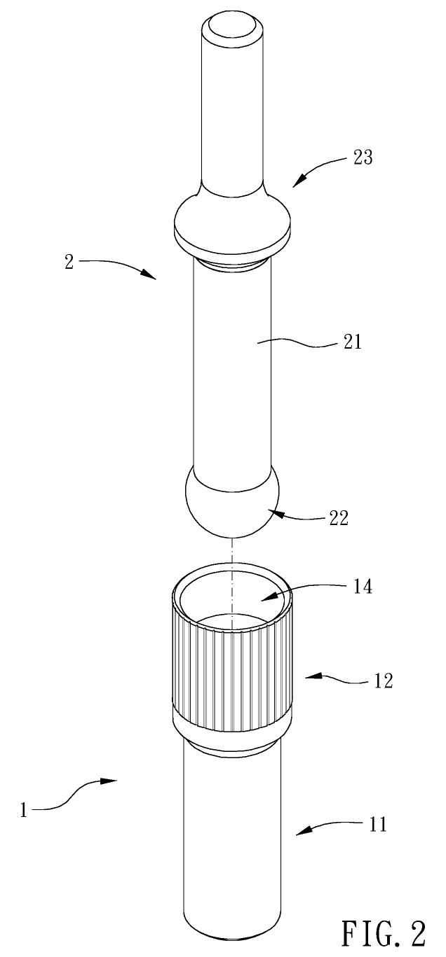

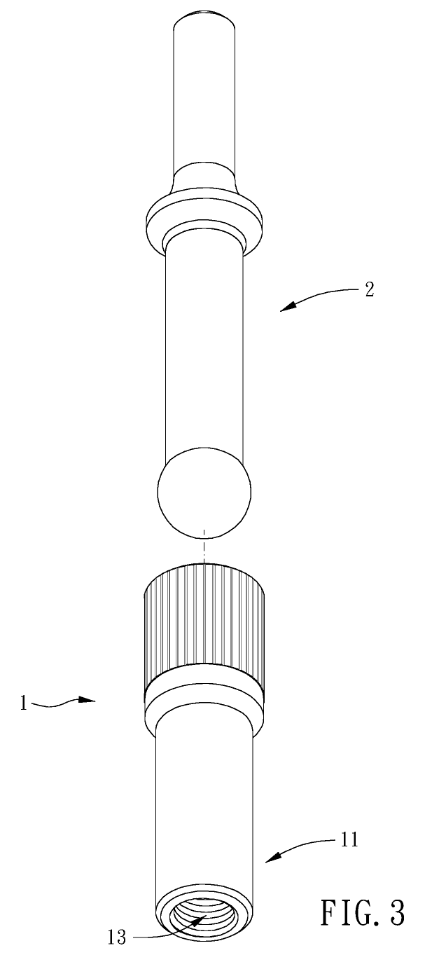

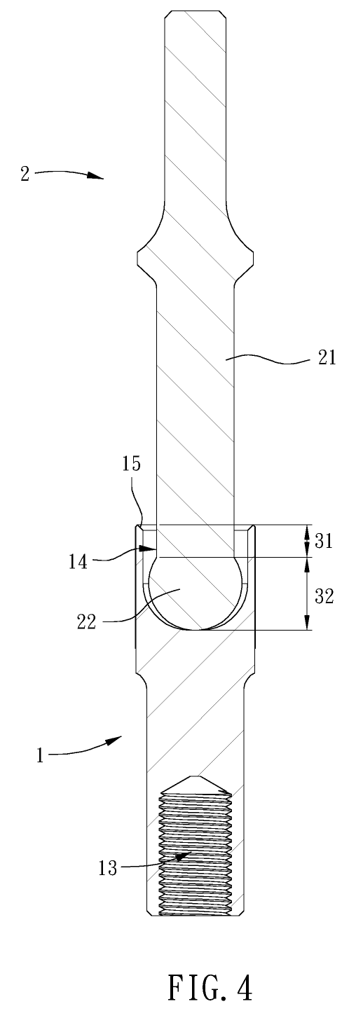

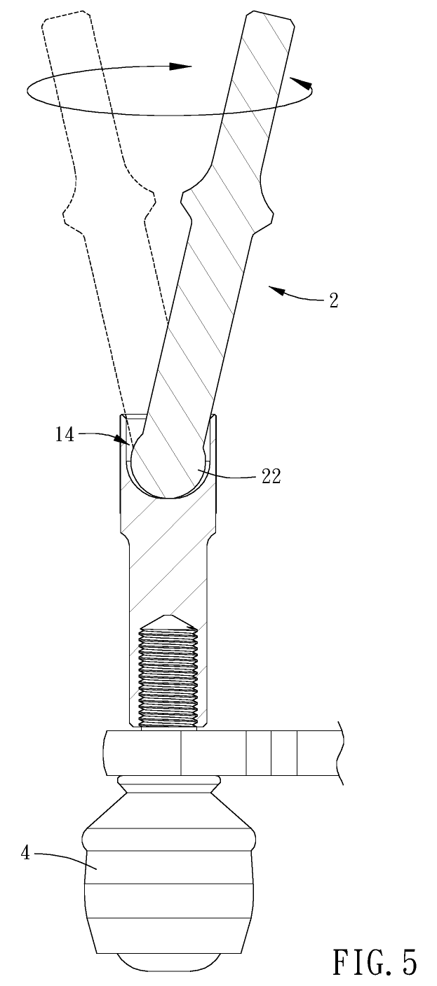

Please refer to FIGS. 1 to 5 for an exemplary embodiment of the present invention. An impact tool 1 of the present invention includes a connection rod 1 and an impact rod 2.

The connection rod 1 includes a first end portion 11 and a second end portion 12 opposite to each other. The first end portion 11 includes a threaded portion 13 which is configured to be screwed to an object 4 (for example, a ball joint, but not limited thereto). The second end portion 12 includes a receiving hole 14. The impact rod 2 includes a body portion 21, a working portion 22 and an impacting head 23. The working portion 22 and the impacting head 23 are disposed at opposite sides of the body portion 21, respectively. The working portion 22 is rotatably received in the receiving hole 14 such that the impact rod 2 is swingable relative to the connection rod 1. The user can adjust the striking angle as needed, and the impacting head 23 can be connected to an impact tool.

In this embodiment, a maximum diametric dimension of the impact rod 2 is smaller than that of the connection rod 1 to ensure that the connection rod 1 has a larger structural size for bearing impact force. Additionally, the length of the impact rod 2 is greater than that of the connection rod 1, allowing it to be used in confined spaces. Furthermore, in a radial direction of the connection rod 1, a diametric dimension of the receiving hole 14 is greater than a diametric dimension of the working portion 22, providing a larger clearance for movement, so the impact rod 2 can swing within a wider range. Preferably, the working portion 22 is a ball head.

Preferably, the working portion 22 is detachably received in the receiving hole 14, facilitating storage when not in use.

Preferably, a diametric dimension of the second end portion 12 is not less than a diametric dimension of the first end portion 11, ensuring the second end portion 12 has sufficient structural strength to bear the impact force from the impact rod 2.

When the working portion 22 is received in the receiving hole 14, a portion of the body portion 21 is received in the receiving hole 14. When the impact rod 2 swings to an extreme position relative to the connection rod 1, the body portion 21 laterally abuts against an edge of the receiving hole 14. As such, when striking at the extreme position, the edge of the receiving hole 14 can provide lateral support to the impact rod 2, ensuring stable striking.

When the connection rod 1 and the impact rod 2 are coaxially arranged, a length of the portion of the body portion 21 located in the receiving hole 14 in the axial direction of the connection rod 1 is defined as a first dimension 31. A length of the working portion 22 in the axial direction of the connection rod 1 is defined as a second dimension 32, and the second dimension 32 is greater than the first dimension 31. In other words, the portion of the body portion 21 received in the receiving hole 14 is relatively short, ensuring the impact rod 2 retains a large swing amplitude relative to the connection rod 1, and the body portion 21 is not prematurely blocked by the edge of the receiving hole 14.

In this embodiment, the threaded portion 13 is a threaded hole, and the threaded portion 13 is not in communication with the receiving hole 14. In the axial direction of the connection rod 1, a length of the receiving hole 14 is less than a length of the threaded portion 13. Additionally, an end of the second end portion 12 away from the threaded portion 13 includes an inclined end face 15. The inclined end face 15 surrounds the opening of the receiving hole 14 and is tapered in a direction toward the threaded portion 13. This configuration is configured to guide the working portion 22 into the receiving hole 14 during assembling.

Preferably, the connection rod 1 further includes a knurling structure 16 disposed on an outer surface of the second end portion 12 to allow the user to firmly grip the second end portion 12. In this embodiment, the knurling structure 16 is a straight knurling pattern extending parallel to the axial direction of the connection rod 1. In the axial direction of the connection rod 1, a length of the knurling structure 16 is greater than a length of the threaded portion 13.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An impact tool including:
a connection rod including a first end portion and a second end portion opposite to each other, the first end portion including a threaded portion, the threaded portion being configured to be screwed to an object, the second end portion including a receiving hole; and
an impact rod including a body portion, a working portion and an impacting head, the working portion and the impacting head being disposed at opposite ends of the body portion respectively, the working portion being rotatably received in the receiving hole so that the impact rod is swingable relative to the connection rod.

2. The impact tool of claim 1, wherein the working portion is detachably received in the receiving hole.

3. The impact tool of claim 1, wherein when the working portion is received in the receiving hole, a portion of the body portion is received in the receiving hole, and when the impact rod swings to an extreme position relative to the connection rod, the body portion laterally abuts against an edge of the receiving hole.

4. The impact tool of claim 3, wherein when the connection rod and the impact rod are coaxially arranged, a length of the portion of the body portion located in the receiving hole in an axial direction of the connection rod is defined as a first dimension, a length of the working portion in the axial direction of the connection rod is defined as a second dimension, and the second dimension is greater than the first dimension.

5. The impact tool of claim 1, wherein an end of the second end portion away from the threaded portion includes an inclined end face, the inclined end face surrounds an opening of the receiving hole, and the inclined end face is tapered in a direction toward the threaded portion.

6. The impact tool of claim 1, wherein in an axial direction of the connection rod, a length of the receiving hole is less than a length of the threaded portion.

7. The impact tool of claim 1, wherein a diametric dimension of the second end portion is not less than a diametric dimension of the first end portion.

8. The impact tool of claim 1, wherein the connection rod further includes a knurling structure, and the knurling structure is disposed on an outer surface of the second end portion.

9. The impact tool of claim 8, wherein in an axial direction of the connection rod, a length of the knurling structure is greater than a length of the threaded portion.

10. The impact tool of claim 4, wherein the working portion is detachably received in the receiving hole; an end of the second end portion away from the threaded portion includes an inclined end face, the inclined end face surrounds an opening of the receiving hole, and the inclined end face is tapered in a direction toward the threaded portion; in the axial direction of the connection rod, a length of the receiving hole is less than a length of the threaded portion; a diametric dimension of the second end portion is not less than a diametric dimension of the first end portion; the connection rod further includes a knurling structure disposed on an outer surface of the second end portion; in the axial direction of the connection rod, a length of the knurling structure is greater than a length of the threaded portion; the knurling structure extends in a direction parallel to the axial direction of the connection rod; a maximum diametric dimension of the impact rod is smaller than a maximum diametric dimension of the connection rod; a length of the impact rod is greater than a length of the connection rod; the object is a ball joint; in a radial direction of the connection rod, a diametric dimension of the receiving hole is greater than a diametric dimension of the working portion, and the working portion is a ball head.
